(19) United States
(12) Patent Application Publication
(10) Pub. No.: US 2024/0157299 A1
(43) Pub. Date: May 16, 2024

(54) DIRECT AIR CAPTURE OF CO2 USING LEAF-LIKE LAYERED CONTACTOR COUPLED WITH ELECTRO DIALYSIS BIPOLAR MEMBRANE REGENERATION

(71) Applicant: Carbon Blade Corporation, San Diego, CA (US)

(72) Inventor: Hunaid NULWALA, Pittsburgh, PA (US)

(21) Appl. No.: 18/549,860

(22) PCT Filed: Mar. 10, 2022
(86) PCT No.: PCT/US2022/019693

§ 371 Date: Sep. 8, 2023

Related U.S. Application Data
(60) Provisional application No. 63/159,159, filed on Mar. 10, 2021.

(51) Int. Cl. B01D 61/44; B01D 53/14; B01D 53/62; B01D 69/12; B01D 71/34; B01D 71/36

(52) U.S. Cl. CPC B01D 61/445; B01D 53/1425; B01D 53/62; B01D 69/12; B01D 71/34; B01D 71/36; B01D 2325/38

(57) ABSTRACT

Provided herein is a stand-alone self-powered portable direct-air-capture (DAC) carbon dioxide removal system. In some embodiments the DAC compromises 1) a wind turbine; 2) at least one solar panel; 3) an energy storage device; 4) a liquid-air contactor; 5) an electrodialysis bipolar membrane (EDBM) device; 6) an acid tank; 7) a base tank; 8) a mixing tank, and 9) at least one CO₂ sequestration pump. In some embodiments, the liquid-air contactor overcomes the need to pass large amounts of air over the contactor device using wind. In some embodiments, the EDBM lowers energy requirements to less than 1.2 MJ/Kg CO₂ compared to thermal regeneration systems (3.5-4 MJ/Kg/CO₂).

### FIELD OF THE INVENTION

Provided herein is a stand-alone self-powered portable direct-air-capture (DAC) carbon dioxide removal system that can be used to remove carbon from ambient air.

### BACKGROUND

Global Thermostat (GT) and Carbon Engineering (CE) are considered the most mature systems for direct air capture (DAC) of carbon dioxide. GT technology uses a dry amine-based porous sorbent over a honeycomb structured ceramic monolith. The desorption is performed via a warm humidity (70-90° C.) swing.⁵⁻⁷ The CE system uses a NaOH/KOH solution which reacts with CO₂ forming sodium and/or potassium carbonates which then react with calcium hydroxide to give calcium carbonate precipitates and regenerated NaOH/KOH solution. The CaCO₃ is calcined at elevated temperatures releasing CO₂.⁸ Other existing technologies include, for example, Infinitree LLC (formerly known as Kilimanjaro LLC) which is developing a system based on humidity swing and specifically targets greenhouse gas emissions that require humidity for regeneration.^{9,10} Verdex is developing an ElectroSwing approach to capture CO₂ using quinones;¹¹ however, there are concerns about the decomposition of quinones.¹² Susteon is working on DAC systems using amines and ionic liquids to regenerate CO₂ at lower temperatures (i.e. 85° C.).

Depending on the reporting source, the estimated cost of CO₂ capture from air is estimated to be anywhere from $250-600 per ton. Recent reports indicate newer technologies may lower the cost below $150 per ton in the next 3-5 years, especially in regions with ample low-cost renewable energy available.¹³⁻¹⁵ A need exists for more advanced technologies that can capture carbon at a lower capture cost. The present disclosure is derived in part from the understanding that electrochemical regeneration can facilitate lower cost carbon capture devices and technologies.

A need exists for the widescale deployment of DAC, in which absorbent material returns to its initial state after releasing CO₂ for full reversibility, for example, over hundreds of thousands of cycles with minimal capacity fade. Additionally, a need exists for such a system wherein the cost of construction and deployment is low. A need exists for a device or system that has minimal or no pressure drop. A need also exists for a device or system that has a small footprint and/or that can be seamlessly scaled, self-powered at the site of use and sequestration.

### SUMMARY OF THE INVENTION

The following embodiments are provided.

Embodiment 1 is a liquid air contactor comprising:
a first inlet;
an outlet;
a hydrophobic membrane that has an outer surface that is in contact with the air and an inner surface that is in contact with a basic solution; and
a liquid handling system configured to allow the flow of the basic solution from the inlet to the outlet. Embodiment 1a is the liquid air contactor of embodiment 1 wherein the liquid handling system is configured to allow the flow of the basic solution from the inlet to the outlet through a liquid air contactor with a sandwich structure.

Embodiment 2 is the liquid air contactor of embodiment 1, further comprising a second inlet.

Embodiment 3 is the liquid air contactor of embodiment 2, wherein a recycled basic solution is introduced to the liquid handling system through the second inlet.

Embodiment 4 is the liquid air contactor of embodiment 3, wherein the recycled basic solution is pumped from an electro-dialysis bipolar membrane (EDBM) into the liquid handling system through the second inlet.

Embodiment 5 is the liquid air contactor of embodiment 1, wherein the basic solution leaves the liquid handling system by the outlet and enters a CO₂ stripping unit.

Embodiment 6 is the liquid air contactor of embodiment 1, wherein the hydrophobic membrane comprises a high permeability membrane, or wherein the hydrophobic membrane comprises a porous polymer, or wherein the hydrophobic membrane comprises a material that allows gas to permeate but does not allow liquid to permeate, or wherein the hydrophobic membrane comprises expanded polytetrafluoroethylene (ePTFE), or wherein the hydrophobic membrane comprises polytetrafluoroethylene (PTFE) or wherein the hydrophobic membrane comprises polyvinylidene fluoride (PVDF).

Embodiment 7 is the liquid air contactor of embodiment 1, wherein the basic solution is a metal hydroxide, or the basic solution is a sodium hydroxide solution.

Embodiment 8 is the liquid air contactor of any of embodiments 1 to X, wherein the hydrophobic membrane is chosen to allow ambient air to permeate the hydrophobic membrane and contact the basic solution.

Embodiment 9 is the liquid air contactor of embodiment 9, wherein CO₂ is removed from ambient air upon reaction with the basic solution in the liquid handling system.

Embodiment 10 is the liquid air contactor of embodiment 9, wherein CO₂ that is removed from the air upon reaction with the basic solution in the liquid handling system is converted to an aqueous carbonate compound solution, or is converted to an aqueous NaHCO₃ solution, that leaves the liquid air contactor through the outlet.

Embodiment 11 is the liquid air contactor of embodiment 9, wherein the air that exits the liquid air contactor has from 5% to 80% less CO₂ than the air that enters the liquid air contactor, or from 10% to 70% less CO₂ than the air that enters the liquid air contactor, or from 20% to 70% less CO₂ than the air that enters the liquid air contactor, or from 30% to 70% less CO₂ than the air that enters the liquid air contactor, or from 40% to 70% less CO₂ than the air that enters the liquid air, or from 50% to 70% less CO₂ than the air that enters the liquid air contactor, or about 60% less CO₂ than the air that enters the liquid air contactor.

Embodiment 12 is the liquid air contactor of embodiment 1, wherein the hydrophobic membrane is configured to have
a top layer membrane that has an outer surface that is in contact with the air and an inner surface that is in contact with a basic solution;
a bottom layer membrane that has an outer surface that is in contact with the air and an inner surface that is in contact with a basic solution; and
an adhesive between a portion of the inner surfaces of the top layer membrane and the bottom layer membrane that seals the top layer membrane to the bottom layer membrane;
wherein the liquid handling system is between the top layer membrane and the bottom layer membrane.

Embodiment 13 is a direct-air-capture (DAC) system comprising the liquid air contactor of any one of embodiments 1 to 12.

Embodiment 14 is the integrated DAC of embodiment 13, further comprising an electrodialysis bipolar membrane (EDBM) device; a CO₂ stripping unit; and at least one CO₂ sequestration pump.

Embodiment 15 is the integrated DAC of embodiment 14, further comprising an energy storage device and an energy supply device chosen from a wind turbine, solar panels or a combination of both wind turbine and solar panels.

Embodiment 16 is a process for removing CO₂ from ambient air comprising contacting ambient air with a direct-air-capture (DAC) system comprising the liquid air contactor of any one of embodiments 1 to 12.

Embodiment 17 is the process of embodiment 16, wherein the DAC further comprises an electrodialysis bipolar membrane (EDBM) device; a CO₂ stripping unit; and at least one CO₂ sequestration pump.

Embodiment 18 is the process of embodiment 17, wherein the DAC further comprises and energy storage device and an energy supply device chosen from a wind turbine, solar panels or a combination of both wind turbine and solar panels.

Embodiment 19 is the process of embodiment 18, wherein ambient air enters the liquid air contactor and contacts the basic solution and a portion of the CO₂ in the ambient air reacts with the basic solution and is removed from the air and captured in the basic solution.

Embodiment 20 is the process of embodiment 19 wherein the basic solution is a sodium hydroxide solution and the CO₂ is captured in the basic solution as a carbonate compound that leaves the liquid air contactor through the outlet.

Embodiment 21 is the process of any one of embodiments 16 to 20 wherein the air that exits the liquid air contactor has from 5% to 80% less CO₂ than the air that enters the liquid air contactor, or from 10% to 70% less CO₂ than the air that enters the liquid air contactor, or from 20% to 70% less CO₂ than the air that enters the liquid air contactor, or from 30% to 70% less CO₂ than the air that enters the liquid air contactor, or from 40% to 70% less CO₂ than the air that enters the liquid air, or from 50% to 70% less CO₂ than the air that enters the liquid air contactor, or about 60% less CO₂ than the air that enters the liquid air contactor.

Embodiment 22 is the process of any one of embodiments 16 to 21 wherein the CO₂ that was captured in the basic solution as a carbonate compound and that leaves the liquid air contactor through the outlet enters the CO₂ stripping unit.

Embodiment 23 is the process of embodiment 22 wherein an aqueous acidic solution is added to the CO₂ stripping unit generating CO₂ gas and an aqueous salt solution.

Embodiment 24 is the process of embodiment 23 wherein a sulfuric acid solution is added to the CO₂ stripping unit generating CO₂ gas and an aqueous sodium sulfate solution.

Embodiment 25 is the process of embodiment 23 or embodiment 24, wherein the CO₂ gas is sequestered using the CO₂ sequestration pump.

Embodiment 26 is the process of embodiment 23 or embodiment 24, wherein the aqueous salt solution or the aqueous sodium sulfate solution is pumped to the EDBM.

Embodiment 27 is the process of embodiment 26, wherein the EDBM provides recycled the basic solution and a recycled acidic solution.

Embodiment 28 is the process of embodiment 27, where in the recycled basic solution is pumped into the liquid air contactor through the second inlet.

Embodiment 29 is the process of embodiment 28, where in the recycled acid solution is pumped into the CO₂ stripping unit.

Embodiment 30 is the process of any one of embodiments 18 to 29 wherein the DAC is self-powered

Embodiment 31 is the process of any one of embodiments 18 to 29 wherein the DAC is powered by the solar energy panels in combination with the energy storage device.

Embodiment 32 is the process of any one of embodiments 18 to 29 wherein the DAC is powered by the wind turbine in combination with the energy storage device.

Embodiment 33 is the process of any one of embodiments 18 to 29 wherein the DAC is powered by the solar energy panels in combination with the wind turbine in combination with the energy storage device.

Embodiment 34 is a device for capturing CO₂ from the air, the device comprising: at least two hydrophobic porous membranes configured in a sandwich structure, the sandwich structure channels configured for an alkaline liquid to flow between the hydrophobic porous membranes; and an adhesive that binds the two hydrophobic porous membranes into the sandwich structure.

Embodiment 34a is a device for capturing CO₂ from the air, the device comprising: at least a hydrophobic porous membrane configured in a sandwich structure, the sandwich structure may comprise channels or large civility configured for an alkaline liquid to flow between the hydrophobic porous membranes; and an adhesive that binds the two hydrophobic porous membranes into the sandwich structure.

Embodiment 35 is the device of embodiment 34, wherein the adhesive creates the channels.

Embodiment 36 is the device of embodiment 34 or 35, wherein the device is integrated into a windsail of an air contactor.

Embodiment 37 is the device of embodiment 34 or 35, wherein the device is mounted on a rotor.

### BRIEF DESCRIPTION OF THE DRAWINGS

FIG. 1 shows a representation of a self-contained system to capture CO₂ from air as described herein with contactor device (1-1), integrated wind (1-2), and solar electrical system (1-3) with battery storage in the trailer unit (1-4).

FIG. 2 shows an representation of a displacement apparatus to quantify the CO₂ evolution.

FIG. 3 a process flow diagram for (A) CO₂ capture (B) stripping of CO₂ from the air by, for example, reaction of acid with a base releasing CO₂, (C) an electrodialysis bipolar membrane (EDBM) system to regenerate the stripping solution, for example, NaOH and H₂SO₄ solution, and (D) sequestration.

FIGS. 4A-4G illustrate a number of prototype liquid air contactor units which have been constructed and tested for CO₂ capture efficiency in the laboratory. FIG. 4A shows prototype 1. FIG. 4B shows prototype 2. FIG. 4C shows prototype 3. FIG. 4D shows prototype 4. FIG. 4E shows prototype 5. FIG. 4F shows prototype 6 and FIG. 4G shows prototype 6 in operation.

FIG. 5 shows a representation of the liquid handling structure beneath a high permeability membrane in a liquid-air contactor.

FIG. 6 shows a table of properties of commercially available hydrophobic membranes.

### DESCRIPTION

The direct air capture system comprising the liquid-air contactor disclosed herein offers many benefits over the currently available DAC processes. In some embodiments, those advantages include one or more of i) temperature-independent adsorption and desorption of CO₂, ii) self-generating by use of wind or solar power plus energy storage systems, iii) can be integrated into the electrical grid, iv) a robust reagents regeneration system and v) a small footprint, for example, the size of a large camping vehicle 40′×8.5, vi) can be moved to the sequestration site and has utilization size as needed. Table 1 shows a comparison between the proposed system and other systems.

TABLE 1
Comparison of proposed system with currently available DAC processes

| | | | | Estimated cost of |
|---|---|---|---|---|
| Company | Technology | Humidity impact | Regeneration | capture $/ton |
| RoCo | Alkali solvent system | NA | Electrical | >$50 |
| | (Leaf-like contractor) | | | |
| Susteon | Ionic Liquid catalyzed | NA | Thermal(85- | $100 |
| | porous sorbent | | 90° C.) | |
| Carbon | NaOH/KOH with | NA | Thermal | 250-600 |
| Engineering | calcination | | | |
| Global | Porous honeycomb solid | Needs humidity to | Thermal (85- | $100 |
| Thermostat | amine sorbents | regenerate | 90° C.) | |
| Verdex | Electroswing | | Electrical | Unknown |
| | (Utilizes quinone | | | |
| | chemistry) | | | |

In some embodiments, the disclosed process is 100% electrochemical. In some embodiments, the disclosed process does not require heat, humidity, and/or a pressure swing. In some embodiments, this technology is a standalone system. In some embodiments, the unit itself does not have a pressure drop associated with surface regeneration due to the motion of the air and the rotation of the blades. In some embodiments, the liquid-air contactor disclosed herein overcomes the need to pass large amounts of air over the contactor device using wind. In some embodiments, the EDBM significantly lowers energy requirement, for example to less than 1.2 MJ/Kg CO₂ compared to thermal regeneration systems (3.5-4 MJ/Kg/CO₂).

In some embodiments, provided herein is a self-contained system which requires no outside energy to capture CO₂ from air comprising A) a leaf-like blade system; B) a reaction of acid with a base releasing CO₂; and C) an EDBM system to regenerate NaOH and H₂SO₄ solution.

In some embodiments, provided herein is a self-contained system to capture CO₂ from air comprising 1) a wind turbine; 2) at least one solar panel; 3) an energy storage device; 4) a liquid-air contactor; 5) an electrodialysis bipolar membrane (EDBM) device; 6) an acid tank; 7) a base tank; 8) a mixing tank, and 9) at least one CO₂ sequestration pump.

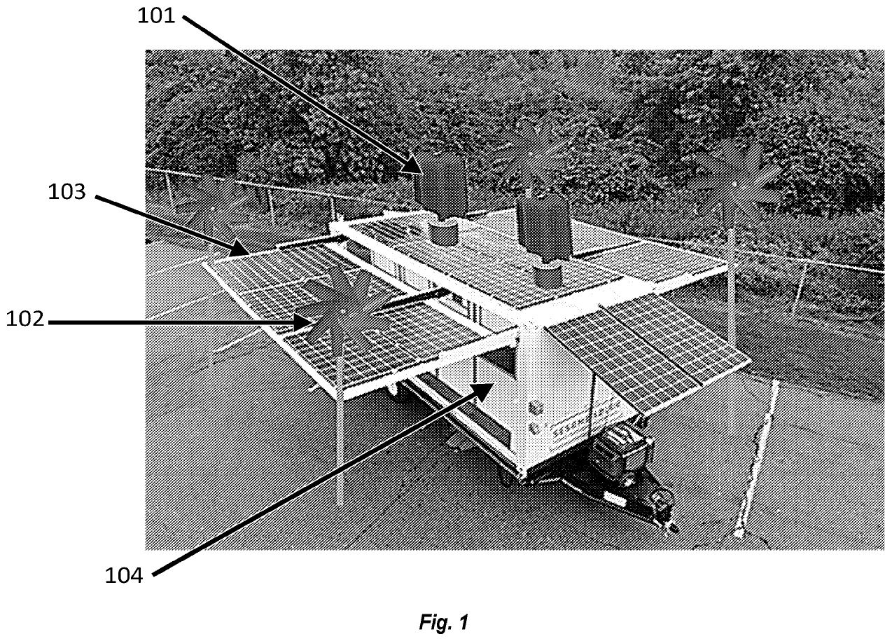

FIG. 1 is a conceptualization of a DAC integrated system as described herein. The air contactor (101) which can be placed near or on top of the power generation unit. Air turbines can be used (102) to generate electricity and a variety of solar cells (103) can be placed above the trailer unit to generate power. The interior of trailer like unit (104) is conceptualized as the area containing the batteries, mixing tanks, and Electro Dialysis Bipolar Membrane subunit.

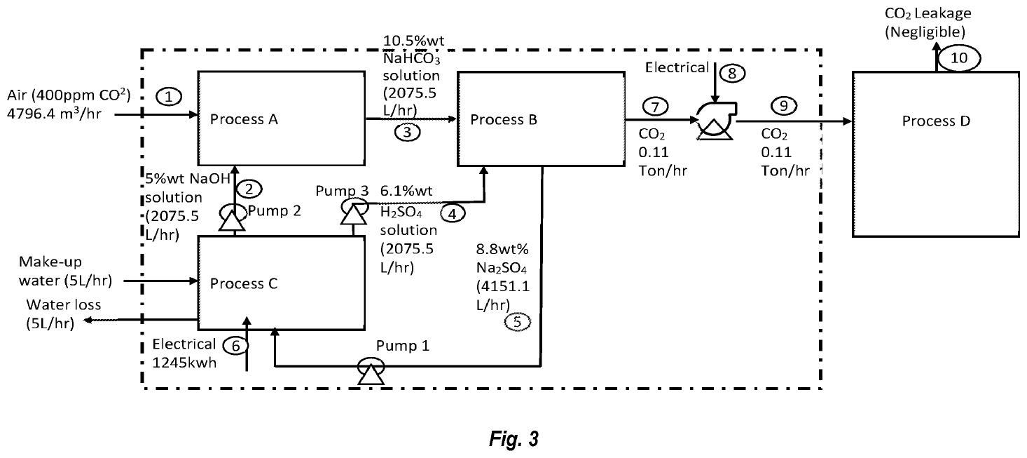

In some embodiments, the DAC system operates as shown in the flow diagram in FIG. 3. Ambient air enters the system (FIG. 3 step 1) and is captured in the liquid air contactor unit where it comes into contact with a basic solution, for example, 5 wt % NaOH solution, (FIG. 3 step 2), and where the following reaction of CO₂₍ₐᵢᵣ₎+NaOH_{(aq)}→NaHCO_{3(aq)} (Process A) can occur. CO₂ captured in from the air in Process A is stripped or separated from the solution by an acid base reaction: NaHCO_{3(aq)}+H₂SO_{4(aq)}→Na₂SO_{4(aq)}+CO_{2(g)} (Process B) (FIG. 3 step 3), and is sequestered (Process D) (FIG. 3 steps 7-10). CO₂ can be stored, for example, in abandoned oil and gas wells. This is known as geological sequestration. The waste stream of Na₂SO₄ from Process B is sent to the EDBM which regenerates the acid and base: 2e⁻Na₂SO₄+2H₂O→NaOH_{(aq)}+H₂SO_{4(aq)} (Process C) (FIG. 3 step 5) used in Processes A and B.

In some embodiments, the system removes CO₂ and/or carbon from ambient air. In some embodiments, the air that exits the liquid air contactor, for example a liquid air contactor in a DAC, has from 5% to 80% less CO₂ than the air that enters the liquid air contactor, or from 10% to 70% less CO₂ than the air that enters the liquid air contactor, or from 20% to 70% less CO₂ than the air that enters the liquid air contactor, or from 30% to 70% less CO₂ than the air that enters the liquid air contactor, or from 40% to 70% less CO₂ than the air that enters the liquid air, or from 50% to 70% less CO₂ than the air that enters the liquid air contactor, or about 60% less CO₂ than the air that enters the liquid air contactor.

Provided herein are methods of removing CO₂ from ambient air comprising contacting air with a liquid air contactor as described herein. Also provided are methods of removing CO₂ from ambient air comprising contacting air with a DAC as described herein.

### Liquid Air Contactor (Leaf-Like Liquid Air Contactor)

In some embodiments, provided herein is a liquid-air contactor comprising
a first inlet;
an outlet;
a hydrophobic membrane that has an outer surface that is in contact with the air and an inner surface that is in contact with a basic solution; and
a liquid handling system configured to allow the flow of the basic solution from the inlet to the outlet.

In some embodiments, liquid-air contactor further comprising a second inlet. In some embodiments, a recycled basic solution is introduced to the liquid handling system through the second inlet.

In some embodiments, the liquid air contactor comprises a high permeability hydrophobic membrane (also referred to herein as “membrane” or “hydrophobic membrane”) that has an outer surface that is in contact with the air and an inner surface. In some embodiments, the membrane allows air and gases to pass into the liquid-air contactor, but does not allow liquids to pass through the membrane. In some embodiments, the hydrophobic membrane is comprised of a porous polymer. In some embodiments, the hydrophobic membrane comprises a material that allows gas to permeate the membrane but does not allow liquid to permeate the membrane.

In some embodiments, the hydrophobic membrane is configured to have a top layer membrane that has an outer surface that is in contact with the air and an inner surface that is in contact with a basic solution; a bottom layer membrane that has an outer surface that is in contact with the air and an inner surface that is in contact with a basic solution; and an adhesive between a portion of the inner surfaces of the top layer membrane and the bottom layer membrane that seals the top layer membrane to the bottom layer membrane; wherein the liquid handling system is between the top layer membrane and the bottom layer membrane.

In some embodiments, the membrane may be made of polytetrafluoroethylene (PTFE) or expanded polytetrafluoroethylene (e-PTFE), or polyvinylidene fluoride (PVDF). Without wishing to be bound by theory, it is believed that a polymer with a porous structure allows the air to interact with NaOH solution. The liquid flow and the motion of the contactor results in continuous refreshing of the reactive surface.

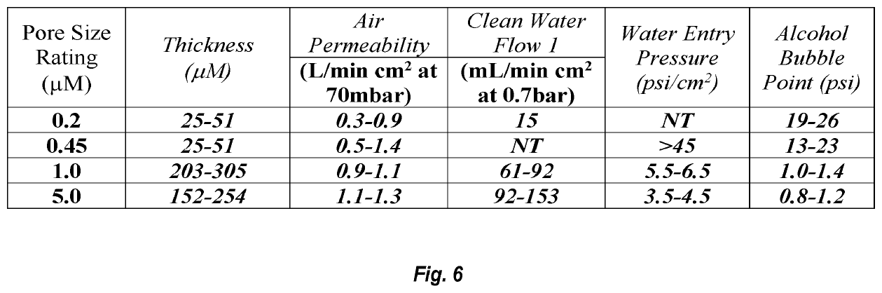

The PVDF, PTFE and/or e-PTFE membranes with desired properties are commercially available. Key properties of membranes are provided in the table in FIG. 6.

In some embodiments, the water entry pressure is selected to ensure that water does not permeate through and to allow the capture solvent to remain between a sandwich Leaf-Like structure. In some embodiments, the air permeability is high to facilitate CO₂ contact with basic solution.

In some embodiments, the liquid air contactor comprises a liquid handling system that is in contact with the high permeability membrane. The liquid handling system allows for the flow of a basic solution from an inlet to an outlet of the liquid air contactor and allows for the air that has passed through the high permeability membrane to come into contact with the basic solution. The liquid handling system also allows for the use of recycled base from the EDBM as the basic solution.

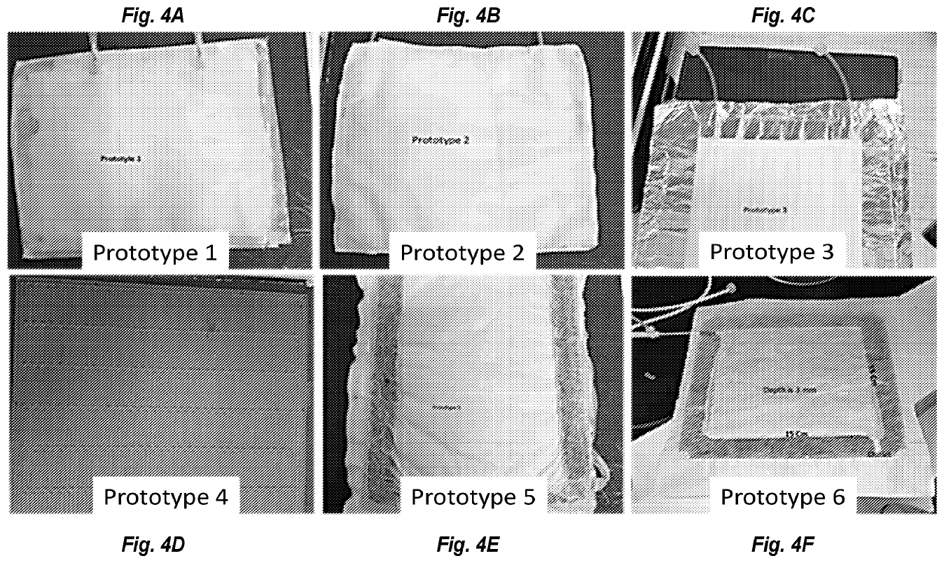

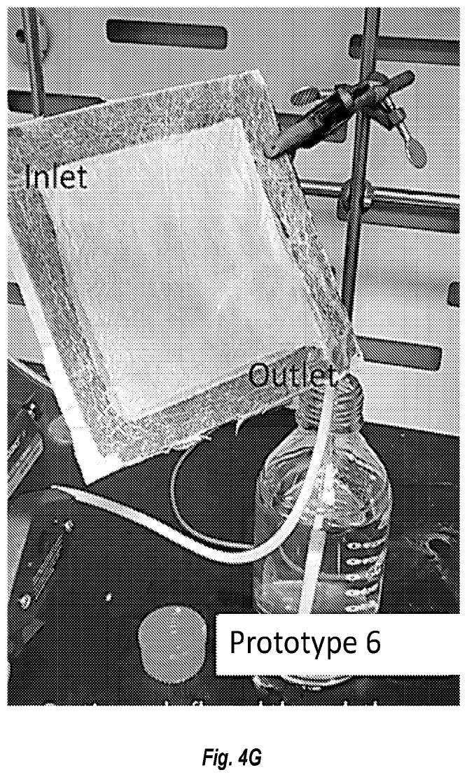

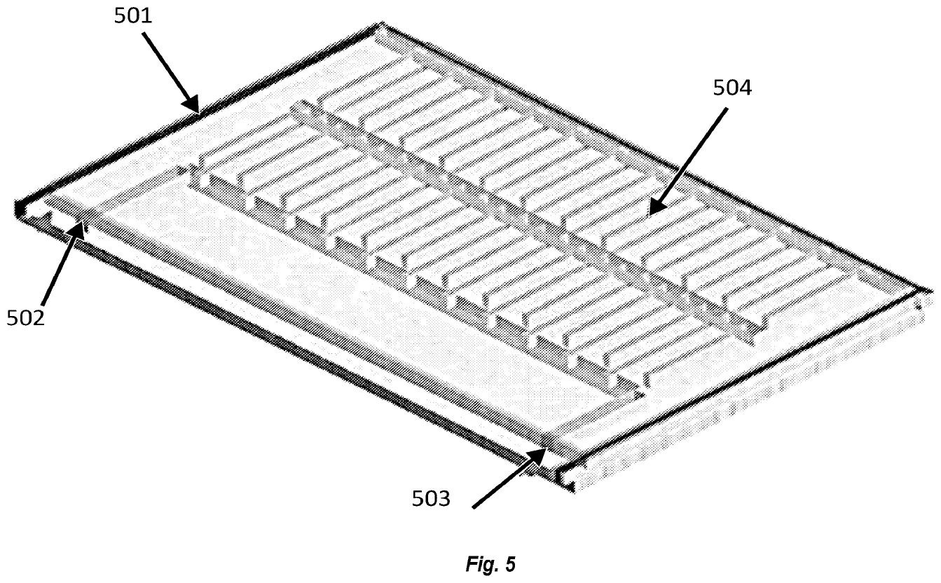

In some embodiments, the liquid air contactor comprises a base tray which contains the liquid handling system. In some embodiments, a portion of the inner surface of the high permeability membrane is connected to the base tray with an adhesive. In some embodiments, the liquid air contractor comprises two hydrophobic membranes held together with an adhesive. The hydrophibic membrane may comprise PVDF, PTFE or e-PTFE, for example. Any adhesive can be used provided it allows for the membrane to adhere to the base tray or to itself. Exemplary adhesives include epoxy, polyolefins block co-polymers, acrylates, and acrylocynates. In some embodiments, the base tray is another layer of the high permeability membrane. An example of a liquid handling system is shown in FIG. 5 (501) with channels (504) and an inlet (502) and an outlet (503). Prototype Leaf-Like air contactors are shown in FIGS. 4A-4G.

In some embodiments, the hydrophobic membrane keeps the capture medium, or basic solution, for example an NaOH solution, contained within the liquid air contactor.

In some embodiments, a liquid air contactor is designed to capture CO₂ directly from air. In some embodiments, the liquid air contactor passes the base solution through the membrane and does not require a fan to pass air on the surface of the capturing area.

In some embodiments, a liquid air contactor, for example a Leaf-Like contractor, can be fabricated by one or more processes such as inkjet printing, screen printing, roll pattern transfer coupled with injection molding, compression molding, stamping, and 3-D printing.

### Electrodialysis Bipolar Membrane

Electrodialysis bipolar membranes are known in the art and are devices that split water into hydroxide ions and protons. The produced hydroxide ion and proton are separated by migration in the respective membrane layer and combined with the counter anions. Unlike water splitting at electrodes during electrolysis, there are no gases formed as a side product, nor are gases used, thus significantly simplifying the overall system.

In some embodiments, electro-dialysis bipolar membrane (EDBM) can be used to overcome the cost associated with regeneration.¹ It is believed that EDBM solvent regeneration may result in significantly lower energy requirements, for example, of 1 to 1.5 MJ/Kg CO₂, or for example, 1.18 MJ/KgCO₂, due to its high efficiency, compared to thermal regeneration systems (3.5-4 MJ/Kg/CO₂) which uses liquid amine solvents/sorbents thus resulting in major energy savings.

### Integration with Wind-turbines

In some embodiments, the DAC system (FIG. 1) may include at least one wind turbine (102). Any existing wind turbine can be integrated into the DAC for generation of electricity. In some embodiments the wind turbine allows the system to be self-sufficient. In some embodiments a small footprint wind turbine is preferred. In some embodiments the wind turbine generates 0.2 kWh of energy. Examples of useful wind turbines include but are not limited to The EnergiPlant Tumo-Int 1000W Wind Turbine Generator, WINDMILL 1500W Wind Turbine, lantern type wind turbines, turbines with linear blades, turbines with lantern shape. In some embodiments more than one wind turbine is placed on a unit to maximize the energy needed for the overall process.

### Integration with Solar Panels

In some embodiments, the DAC system (FIG. 1) may include at least one solar panel (103). Any known solar panel can be used, such as Organic solar cells, dye synthetized organic solar cell. In some embodiments the solar cell will generate 0.2 mwh of energy. Examples of useful solar technology includes but is not limited to Monocrystalline solar panels, Polycrystalline solar panels Passivated Emitter and Rear Cell (PERC) panels, Copper indium gallium selenide (CIGS), Cadmium telluride (CdTe) and Amorphous silicon (a-Si) and similar.

### Integration with an Energy Storage Device

In some embodiments, the DAC system (FIG. 1) may include a device (104) to store the energy from either the solar panel (103) or the wind turbine (102). Any known storage devices can be used, for example a battery, provided the unit can store at least 0.5 mwh of energy. Examples of useful energy storage devises include, but are not limited to a battery such as Aluminium-ion battery, Calcium battery, Flow battery, Vanadium redox battery, Zinc-bromine battery, Zinc-cerium battery, Hydrogen bromine battery Lead-acid battery, Deep-cycle battery, VRLA battery, AGM battery, Gel battery, Lithium-ion battery, Lithium-ion lithium cobalt oxide battery (ICR), Lithium-silicon battery, Lithium-ion manganese-oxide battery (LMO), Lithium-ion polymer battery (LiPo), Lithium-iron-phosphate battery (LFP), Lithium-nickel-manganese-cobalt oxides (NMC), Lithium-nickel-cobalt-aluminium oxides (NCA), Lithium-sulfur battery, Lithium-titanate battery (LTO), Thin-film lithium-ion battery, Lithium-ceramic battery, Rechargeable lithium-metal battery, Magnesium-ion battery, Metal-air electrochemical cells, Lithium-air battery, Aluminium-air battery, Germanium-air battery, Calcium-air battery, Iron-air battery, Potassium-ion battery, Silicon-air battery, Zinc-air battery, Tin-air battery, Sodium-air battery, Beryllium-air battery, Molten-salt battery, Microbial fuel cell, Nickel-cadmium battery, Nickel-iron battery, Nickel-metal hydride battery, Nickel-zinc battery, Organic radical battery, Polymer-based battery, Polysulfide bromide battery, Potassium-ion battery, Rechargeable alkaline battery, Rechargeable fuel battery, Sand battery, Silicon-air battery, Silver-zinc battery, Silver-calcium battery, Silver-cadmium battery, Sodium-ion battery, Sodium-sulfur battery, Solid-state batteries, Super iron battery and Zinc-ion battery.

### Integration with a CO₂ Sequestration Pump

CO₂ sequestration pumps are known in the art. Any known pump capable of compressing CO₂ gas can be used provided the compressor can handle inlet volume of at least 500 Inlet Volume (m³/h). Examples of useful pumps include but are not limited to screw, reciprocating, centrifugal and or internally geared systems.

### EXAMPLES

### Example 1 Preparation of Prototyped 1-6

Prototype 1 (FIG. 4A) was made from two films of 1 micron PVDF (Tisch Scientific Polyvinylidene Fluoride (PVDF) membrane roll stock, 1 um, 300 mm (width)×3 m (length), with PET substrate, RS20133) backed by non-woven polypropylene (PP) that were sandwiched together with a poly(ionic liquid) adhesive of the formula I below.

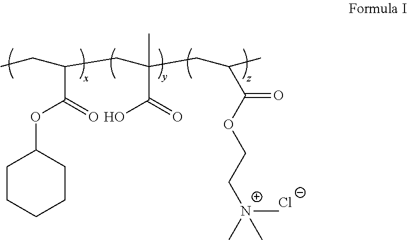

The inlet and the outlet were created by sandwiching a needle. The poly(ionic liquid) adhesive was brushed on the edges and then the edges were pressed together. The device failed as a number of leakages sprung up at the corners as well as where the liquid input needles were connected within 30 minutes.

Prototype 2 (FIG. 4B) was made from two films of 1 micron PVDF backed by non-woven PP that were sandwiched together with a poly(ionic liquid) adhesive of Formula I. PTFE tubing was used rather than the syringe needles used in Prototype 1. The poly(ionic liquid) adhesive was brushed on the edges and then the edges were pressed together. The device failed as a number of leakages sprung up at the corners as well as connecting point of the inlet tubing were connected within 30 minutes. Although this prototype performed better than the prototype 1, it failed sometime after 30 minutes.

Prototype 3 (FIG. 4C) was made from 1 micron PVDF backed by non-woven PP sandwiched together with the poly(ionic liquid) adhesive of Formula I. This unit was then covered with adhesive metal tape to provide additional strength. The unit failed after one hour of testing as the leaks started to occur within the device at the edges.

Prototype 4 (FIG. 4D) was made from PP 3D printed with E-shaped channels running through the unit. The material of construction was PP. 1 micron PVDF backed with PP membrane material adhered on top of this prototype. This unit could not be tested due to the inlet and outlet channels failing during the testing.

Prototype 5 (FIG. 4E) was made using a frame built from PVC. The middle is packed with PP non-woven foam. The inlet and outlet run through the PVC frame. The membrane was PVDF backed with PP membrane material adhered on top of this prototype. No leaks were formed during testing. However little or no CO₂ was captured in this device. This was mainly attributed to the fact that CO₂ capture solution went through the middle of the device and was not exposed to the air given that it was likely flowing through the middle of the device.

Prototype 6 (FIG. 4F and 4G) was made using a rectangular bracket 15 cm×15 cm and 3 mm deep. (Surface area of 225 cm²). Two holes were drilled for the metal tubing which were fixed with a polyvinyl chloride (PVC) joint compound. The surface of the prototype was covered with a high permeability PP-backed hydrophobic PVDF membrane, which allowed the air to interact with the NaOH solution but minimized the water loss. Commercially available block copolymer was used as the adhesive. (INFUSE). A gasket was first developed by pressing INFUSE at 170 C at 1000 Psi pressure in a Carver press. A gasket was cut out. The membrane, the gasket, and the PVC holder were pressed together in the craver press at 170 C for 2 minutes. This prototype didn't leak or fail. We used a peristaltic pumping system to pass the solution through the prototype continuously. A 5% NaOH solution (1 L) was circulated continuously through the prototype for 22 hours. The airflow was kept at 200 mL/min around the device resulting in capturing 32 mL of the CO₂ during that time. Which is 60% of total CO₂ passed over the membrane surface on that surface.

This prototype demonstrated a high capture efficiency at approximately 60% from the air. Based on this data it is estimated that approximately 7-8-km/hr. wind speed is needed to approximately remove 1-ton of CO₂ per day with a large rotating unit with a surface area of 200-m² of the contactor.

Test results from the initial prototype 6 device shown in FIGS. 4F and 4G with average air velocity of 200 mL per minutes over the surface.

| | | | Surface | | | | |
|---|---|---|---|---|---|---|---|
| | | Refresh | area of | | Total number | CO_{2 (g)} | |
| | Flow Rate | Rate | test device | Time | capture | mL | Moles of CO₂ |
| | (mL) | (mL/min) | (cm²) | (Min) | solution cycles | captured | capture |
| 6 | 10.00 | 0.675 | 225 | 1320 | 1956 | 33 | 0.001473 |

### Example 2: Displacement Measurements to Quantify CO₂ Evolution

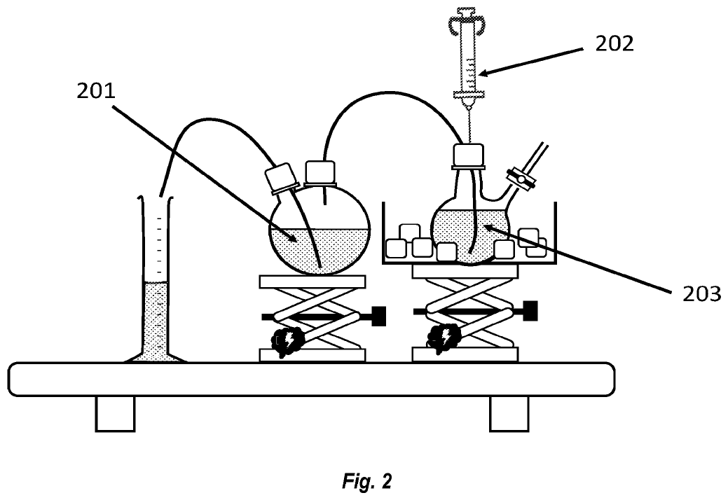

FIG. 2 shows the apparatus for measuring CO₂ evolution from a liter of the 5% NaOH solution from the contactor device in 2 L flasks. A large liquid volume was used deliberately to mitigate the error associated with gas evolution. Flask (201) contained water. The flask (203) containing NaOH and NaHCO₃ was placed in an ice bath to mitigate heat evolved during the acid-base reaction. The sulfuric acid (202) was added slowly to minimize the variations with heat expansion. The volume of acid was subtracted from the evolved gas to get an accurate value.

### Example 3: References

1. Valluri, S., Kawatra, S. K. Fuel Process. Technol., 2021, 213, 106691.
2. https://www.fumatech.com/EN/Membrane-processes/Process%2Bdescription/Bipolar-membranes/index.html (accessed Feb. 28, 2021).
3. https://www.lenntech.com/processes/bipolar-membrane-electrodialysis-edbm-.htm (accessed Feb. 28, 2021).
4. https://newscenter.lbl.gov/2019/08/26/report-confirms-wind-technology-advancements-continue-to-drive-down-the-cost-of-wind-energy/ (accessed Feb. 28, 2021).
5. https://globalthermostat.com/ (accessed Feb. 18, 2021).
6. Choi, S., Drese, J. H., Eisenberger, P. M., Jones, C. W. Environ. Sci. Technol., 2011, 45, 2420-2427.
7. Kumar, D. R., Rosu, C., Sujan, A. R., Sakwa-Novak, M. A., Ping, E. W., Jones, C. W. ACS Sustain. Chem. Eng., 2020, 8, 10971-10982.
8. https://carbonengineering.com/ (accessed Feb. 18, 2021).
9. Wang, Q., Zhang, Q., Chen, B., Lu, X., Zhang, S. J. Electrochem. Soc., 2015, 162, D320-D324.
10. He, H., Li, W., Lamson, M., Zhong, M., Konkolewicz, D., Hui, C. M., Yaccato, K., Rappold, T., Sugar, G., David, N. E., Damodaran, K., Natesakhawat, S., Nulwala, H., Matyjaszewski, K. Polymer (Guildf)., 2014, 55, 385-394.
11. Voskian, S., Hatton, T. A. Energy Environ. Sci., 2019, 12, 3530-3547.
12. Watkins, J. D., Siefert, N. S., Zhou, X., Myers, C. R., Kitchin, J. R., Hopkinson, D. P., Nulwala, H. B. Energy & Fuels, 2015, 29, 7508-7515.
13. https://www.wri.org/blog/2021/01/direct-air-capture-definition-cost-considerations (accessed Feb. 18, 2021).
14. Beuttler, C., Charles, L., Wurzbacher, J. Front. Clim., 2019, 1.
15. McQueen, N., Psarras, P., Pilorgé, H., Liguori, S., He, J., Yuan, M., Woodall, C. M., Kian, K., Pierpoint, L., Jurewicz, J., Lucas, J. M., Jacobson, R., Deich, N., Wilcox, J. Environ. Sci. Technol., 2020, 54, 7542-7551.
16. Nulwala, H., Qu, L. WO2017201465A1 2017.
17. https://sbir.nasa.gov/SBIR/abstracts/20/sbir/phase1/SBIR-20-1-Z12.01-4722.html (accessed Mar. 2, 2021).
18. Fasihi, M., Efimova, O., Breyer, C. J. Clean. Prod., 2019, 224, 957-980.
19. Wang, Y., Zhao, L., Otto, A., Robinius, M., Stolten, D. In Energy Procedia Elsevier Ltd 2017; vol. 114 650-665.

1. A liquid air contactor comprising:
a first inlet;
an outlet;
a hydrophobic membrane that has an outer surface that is in contact with air and an inner surface that is in contact with a basic solution; and
a liquid handling system configured to allow flow of the basic solution from the first inlet to the outlet.

2. The liquid air contactor of claim 1, further comprising:
a second inlet, wherein a recycled basic solution is introduced to the liquid handling system through the second inlet.

3. (canceled)

4. The liquid air contactor of claim 2,
an electro-dialysis bipolar membrane (EDBM), wherein the recycled basic solution is configured to be pumped from the EDBM into the liquid handling system through the second inlet.

5. The liquid air contactor of claim 1, wherein the basic solution is configured to leave the liquid handling system by the outlet and to enter a CO₂ stripping unit.

6. The liquid air contactor of claim 1, wherein the hydrophobic membrane comprises at least one of a high permeability membrane, a porous polymer, a material that allows gas to permeate but does not allow liquid to permeate, or a porous polymer selected from a group consisting of polyvinyl fluoride (PVDF), polytetrafluoroethylene (ePTFE), and expanded polytetrafluoroethylene (ePTFE).

7. The liquid air contactor of claim 1, wherein the basic solution includes a metal hydroxide, or the basic solution is a sodium hydroxide solution.

8. The liquid air contactor of claim 1, wherein the hydrophobic membrane is operable to allow ambient air to permeate the hydrophobic membrane and contact the basic solution.

9. The liquid air contactor of claim 1, wherein the liquid air contactor is configured to allow ambient air enter and contact the basic solution, where a portion of the CO₂ in the ambient air reacts with the basic solution and is removed from the air and captured in the basic solution.

10. The liquid air contactor of claim 9, wherein the CO₂ that is removed from the air upon reaction with the basic solution in the liquid handling system is converted to an aqueous carbonate compound solution, or is converted to an aqueous NaHCO₃ solution, that leaves the liquid air contactor through the outlet.

11. The liquid air contactor of claim 9, wherein the liquid air contactor is configured to allow air to exit, wherein the air that exits the liquid air contactor has from 5% to 80% less CO₂ than the air that enters the liquid air contactor, or from 10% to 70% less CO₂ than the air that enters the liquid air contactor, or from 20% to 70% less CO₂ than the air that enters the liquid air contactor, or from 30% to 70% less CO₂ than the air that enters the liquid air contactor, or from 40% to 70% less CO₂ than the air that enters the liquid air, or from 50% to 70% less CO₂ than the air that enters the liquid air contactor, or about 60% less CO₂ than the air that enters the liquid air contactor.

12. The liquid air contactor of claim 1, wherein the hydrophobic membrane is configured to have:
a top layer membrane that has an outer surface that is in contact with the air and an inner surface that is in contact with a basic solution;
a bottom layer membrane that has an outer surface that is in contact with the air and an inner surface that is in contact with a basic solution; and
an adhesive between a portion of the inner surfaces of the top layer membrane and the bottom layer membrane that seals the top layer membrane to the bottom layer membrane;
wherein the liquid handling system is between the top layer membrane and the bottom layer membrane.

13. A direct-air-capture (DAC) system comprising:
a liquid air contactor, comprising a first inlet, an outlet, a hydrophobic membrane that has an outer surface that is in contact with air and an inner surface that is in contact with a basic solution, and a liquid handling system configured to allow flow of the basic solution from the first inlet to the outlet
an electrodialysis bipolar membrane (EDBM) device;
a CO₂ stripping unit; and
a CO₂ sequestration pump.

14. (canceled)

15. The DAC system of claim 13, further comprising:
an energy storage device and an energy supply device comprising at least one of a wind turbine, solar panels or a combination of both wind turbine and solar panels.

16. (canceled)

17. (canceled)

18. (canceled)

19. The DAC system of claim 13, wherein ambient air enters the liquid air contactor that is configured to facilitate contact with the basic solution, and wherein the liquid air contactor is configured to facilitate a portion of the CO₂ in the ambient air to react with the basic solution and be removed from the air and captured in the basic solution.

20. The DAC system of claim 19, wherein the basic solution includes a sodium hydroxide solution, and wherein the CO₂ is captured in the basic solution as a carbonate compound that is able to leave the liquid air contactor through the outlet.

21. (canceled)

22. The DAC system of claim 20, wherein the CO₂ stripping unit is configured to intake the CO₂ and wherein the CO₂ stripping unit is configured to process the CO₂ with aqueous acidic solution to generate CO₂ gas and an aqueous salt solution.

23. (canceled)

24. The DAC system of claim 22, wherein a sulfuric acid solution is added to the CO₂ stripping unit to generate the CO₂ gas and an aqueous sodium sulfate solution.

25. The DAC system of claim 22, wherein the CO₂ sequestration pump is configured to sequester the CO₂ gas.

26. The DAC system of claim 22, wherein the aqueous salt solution or the aqueous sodium sulfate solution is pumped to the EDBM, and wherein the EDBM is configured to provide a recycled basic solution and a recycled acidic solution.

27. (canceled)

28. The DAC system of claim 26, further comprising:
a second inlet, wherein the recycled basic solution is configured to be pumped into the liquid air contactor through the second inlet, and wherein the recycled acid solution is pumped into the CO₂ stripping unit.

29. (canceled)

30. The DAC system of claim 13, wherein the DAC system is self powered,

31. The DAC system of claim 15,
wherein the DAC system is powered by the solar panels in combination with the energy storage device, or
wherein the DAC is powered by the wind turbine in combination with the energy storage device, or
wherein the DAC is powered by the solar energy panels in combination with wind turbine in combination with the energy storage device.

32. (canceled)

33. (canceled)

34. A device for capturing CO₂ from the air, comprising:
at least two hydrophobic porous membranes configured in a sandwich structure, the sandwich structure comprising channels to allow an alkaline liquid to flow between the at least two hydrophobic porous membranes; and
an adhesive that binds the at least two hydrophobic porous membranes into the sandwich structure to form the channels.

35. (canceled)

36. The device of claim 34, wherein the device is integrated into a windsail of an air contactor.

37. The device of claim 34, wherein the device is mounted on a rotor.
